(19) United States
(12) Patent Application Publication
(10) Pub. No.: US 2003/0203224 A1
(43) Pub. Date: Oct. 30, 2003

(54) Thermal barrier coating of intermediate density

(76) Inventors: Paul Josesh DiConza, Clifton Park, NY (US); Dennis Michael Gray, Delanson, NY (US)

Correspondence Address: General Electric Company, CRD Patent Docket Rm 4A59, M.N. Salamone, P.O. Box 8, Bldg. K1, Schenectady, NY, 12301, US

(21) Appl. No.: 10/440,668

(22) Filed: May 19, 2003

Related U.S. Application Data
(62) Division of application No. 09/682,159, filed on Jul. 30, 2001.

(51) Int. Cl. B32B 9/00

(52) U.S. Cl. 428/472; 428/701; 428/702; 428/332

(57) ABSTRACT

A thermal barrier coating for an article, such as a component of a turbine assembly. The thermal barrier coating comprises a ceramic material and has a plurality of substantially vertical cracks therein and a porosity that is within a predetermined range. The ratio of tensile adhesion strength to modulus of elasticity of the thermal barrier coating has a value of between about 6×10⁻³ and about 15×10⁻³. The thermal barrier coating is formed by air spraying the ceramic material onto a metallic bond coat which has been previously applied to a substrate and heating the coated article to between about 1040° C. and about 1200° C. for a predetermined time.

### BACKGROUND OF INVENTION

The present invention relates to thermal barrier coatings for articles, such as turbine components. The invention also relates to articles having such thermal barrier coatings.

The design of modern gas turbines is driven by the demand for higher turbine efficiency. It is widely recognized that turbine efficiency can be increased by operating the turbine at higher temperatures. In order to assure a satisfactory life span at these higher temperatures, thermal barrier coatings (hereinafter referred to as “TBCs”) are applied to airfoils and combustion components of the turbine, such as transition pieces and combustion liners, using thermal spray techniques. A component having a thicker TBC is more likely have a longer service life at a given operating temperature or, conversely, survive a higher operating temperature for a given lifetime.

Porous thermal barrier coatings,—i.e., coatings having a porosity between 5-25%—are well known in the art. Porous TBCs tend to have a low strain tolerance. The low strain tolerance limits the thickness of the TBC that can be deposited on an article; as the thickness of a porous TBC increases, the accumulation of residual stresses and internal defects combine to diminish the ability of the TBC to accommodate strain prior to spalling.

Dense vertically cracked (hereinafter referred to as “DVC”) TBCs have less than 5% porosity and include a series of vertical cracks generally running through the entire cross-sectional thickness of the TBC. The low porosity gives the coating excellent tensile adhesion strength, while the vertical cracks give the coating the ability to accommodate strains in the substrate plane. DVC coatings, however, have a tight processing window: substrate temperature, powder feed rates, and gun-to-substrate distance are examples of important process parameters. These limitations become problematic when applied to combustion components. These components are much larger than turbine airfoils (for which DVC was originally developed) and require that the TBC be applied to their interior surfaces. Such geometric requirements severely restrict the size of the thermal spray gun that can be used for the coating process. In addition, the large surface areas of these components make it difficult to maintain substrate temperatures during deposition within a range that is considered suitable for generating DVC coatings.

Therefore, what is needed is a thermal barrier coating having adequate thickness and strain tolerance, and yet is easy to manufacture. Finally, what is needed is an article having such a coating.

### SUMMARY OF INVENTION

The present invention meets these and other needs by providing a thermal barrier coating of sufficient thickness and strength for an article, as well as an article comprising such a thermal barrier coating deposited on a bond coat which is in turn deposited on a surface of a substrate. The invention also includes methods of forming a thermal barrier coating on an article and forming an article that comprises a substrate, a bond coat and a thermal barrier coating.

Accordingly, one aspect of the invention is to provide an article comprising: a substrate; a bond coat disposed on a surface of the substrate; and a thermal barrier coating disposed on an outer bond coat surface of the bond coat, wherein the outer bond coat surface is opposite the surface of the substrate. The thermal barrier coating comprises a ceramic material and has a plurality of substantially vertical cracks therein and a porosity that is within a predetermined range. The ratio of tensile adhesion strength to the modulus of elasticity of the thermal barrier coating has a value between about 6×10⁻³ and about 15×10⁻³

A second aspect of the invention is to provide a thermal barrier coating for an article. The thermal barrier coating comprises a ceramic material and has a plurality of substantially vertical cracks therein and a porosity that is within a predetermined range. The ratio of tensile adhesion strength to the modulus of elasticity of the thermal barrier coating has a value between about 6×10⁻³ and about 15×10⁻³.

A third aspect of the invention is to provide an article comprising: a substrate, the substrate comprising one of a superalloy, a ceramic-matrix composite, and a refractory metal intermetallic composite; a bond coat disposed on a surface of the substrate; and an air plasma sprayed thermal barrier coating disposed on an outer bond coat surface of the bond coat, the outer bond coat surface being opposite the surface of the substrate. The thermal barrier coating comprises at least one of a stabilized zirconia, aluminum silicate, calcium silicate, and combinations thereof, and has a plurality of substantially vertical cracks therein and a porosity that is within a predetermined range. The ratio of tensile adhesion strength to the modulus of elasticity of the thermal barrier coating has a value between about 6×10⁻³ and about 15×10⁻³.

A fourth aspect of the invention is to provide a turbine assembly having at least one component. The component comprises: a substrate comprising one of a superalloy and a refractory metal intermetallic composite; a bond coat disposed on a surface of the substrate; and an air plasma sprayed thermal barrier coating disposed on an outer bond coat surface of the bond coat, the outer bond coat surface being opposite the surface of the substrate. The thermal barrier coating comprises at least one of a stabilized zirconia, aluminum silicate, calcium silicate, and combinations thereof, and has a plurality of substantially vertical cracks therein and a porosity that is within a predetermined range. The ratio of tensile adhesion strength to the modulus of elasticity of the thermal barrier coating has a value between about 6×10⁻³ and about 15×10⁻³.

A fifth aspect of the invention is to provide a method of forming a coated article comprising a substrate, a bond coat disposed on the substrate, and a thermal barrier coating disposed on the bond coat. The thermal barrier coating comprises a ceramic material and has a plurality of substantially vertical cracks therein and a porosity that is within a predetermined range. The ratio of tensile adhesion strength to the modulus of elasticity of the thermal barrier coating has a value between about 6×10⁻³ and about 15×10⁻³. The method comprises the steps of: providing a substrate; depositing a bond coat on the substrate; and depositing a thermal barrier coating on the bond coat, thereby forming the coated article.

A sixth aspect of the invention is to provide a method of forming a thermal barrier coating on an article. The thermal barrier coating comprises a ceramic material and has a plurality of substantially vertical cracks therein and a porosity that is within a predetermined range. The ratio of tensile adhesion strength to the modulus of elasticity of the thermal barrier coating has a value between about 6×10⁻³ and about 15×10⁻³. The method comprises the steps of: providing an article; air plasma spraying a coating of ceramic material onto the article; and heat treating the coated article at a temperature between about 1040° C. (about 1900° F.) and about 1200° C. (about 2200° F.).

These and other aspects, advantages, and salient features of the present invention will become apparent from the following detailed description, the accompanying drawings, and the appended claims.

### BRIEF DESCRIPTION OF DRAWINGS

FIG. 1 is a micrograph of a cross-section of a porous TBC of the prior art;

FIG. 2 is a micrograph of a cross-section of a DVC TBC of the prior art; and

FIG. 3 is a micrograph of a cross-section of a TBC of the present invention.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms.

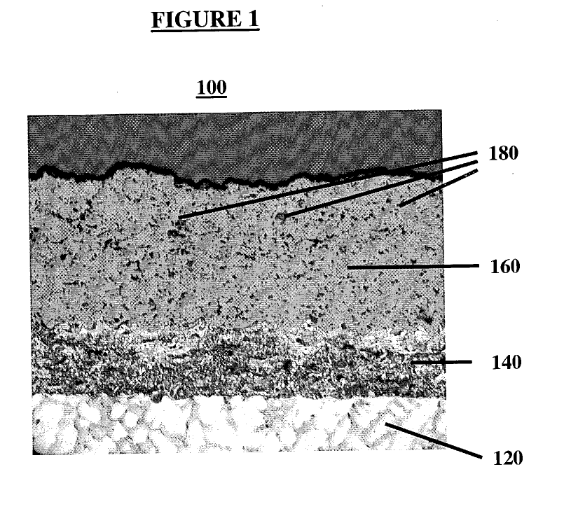

Referring to the drawings in general and to FIG. 1 in particular, it will be understood that the illustrations are for the purpose of describing a preferred embodiment of the invention and are not intended to limit the invention thereto.

Generally, an article having a thermal barrier coating comprises a metallic or ceramic substrate, a metallic bond coat disposed on the surface of the substrate, and a ceramic thermal barrier coating (hereinafter referred to as “TBC”) disposed on an outer surface of the bond coat, opposite the substrate. The article may be a turbine component, such as, but not limited to, a combustion liner (i.e., the inner surface of a combustor) or a transition piece connecting a combustor to a nozzle. It is further contemplated that the article may be a structure, such as a turbine assembly, that includes at least one component having the thermal barrier coating of the present invention. While the embodiments described herein are related to turbine assemblies and components thereof, it should be understood that these embodiments are not intended to limit the invention thereto; other components and structures in which components are exposed to a high temperature fluid medium are considered to fall within the scope of the invention.

The strain tolerance of a thermal barrier coating is related to the compressive shear strain to failure of the TBC. The compressive shear strain to failure can be correlated with the ratio T/E of the coating's tensile adhesion strength (T) to its modulus of elasticity (E). The tensile adhesion strength T of a TBC may be obtained by measuring the stress needed to separate the TBC from the bond coat on which it is deposited, measuring the coherent strength of the TBC perpendicular to the bond coat TBC interface, or by a combination of the two measurements. The modulus of elasticity E is usually determined by using a three-point bend test that is well known in the art, in which displacement of the TBC, which has been separated from the bond coat, is measured as a function of load. The value of the T/E ratio obtained for a TBC serves as a qualitative indicator of the strain tolerance of the TBC.

Two types of thermally sprayed TBCs-porous TBCs and dense vertically cracked (hereinafter referred to as “DVC”) TBCs—are known in the art. FIG. 1 is a micrograph of an article 100 having a porous TBC 160, which contains a plurality of pores 180. Porous TBCs 160 are sometimes classified into two groups: “Class B” TBCs, having a porosity of between about 5% and 15% and a thickness of between about 255 microns (about 10 mil) and about 455 microns (about 18 mil); and “Class C” TBCs, having a porosity of between about 15% and 25% and a thickness of between about 355 microns (about 14 mil) and about 560 microns (about 22 mil).

Porous TBC 160 usually has a strain tolerance of up to about 0.6%. The thickness of porous TBC 160 is limited by the strain tolerance of the coating: as the thickness of porous TBC 160 increases, the coating becomes increasingly susceptible to failure by spallation.

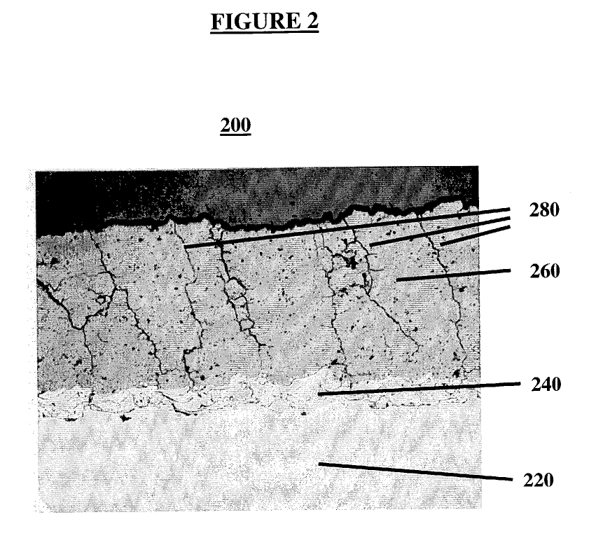

An article 200 having a dense vertically cracked (hereinafter “DVC”) TBC 260 is shown in FIG. 2. The dense vertically cracked TBC 260 typically has less than about 5% porosity and includes a plurality of vertical cracks 280 extending from an outer surface 262 of vertically cracked TBC 260. The low porosity of the dense vertically cracked TBC 260 provides excellent tensile adhesion strength, while the vertical cracks give the coating the ability to accommodate stresses in the plane of the substrate 220. This combination of properties yields a strain tolerance of about 1.4% strain, and thus permits dense vertically cracked TBC 260 to have a greater thickness than porous TBC 260. Dense vertically cracked TBC 260 typically has a thickness of between about 255 microns (about 10 mil) and about 2550 microns (about 100 mil).

The formation of dense vertically cracked TBC 260 requires tight processing controls. In comparison to processes that are used to deposit porous TBC's, substrate 220 is often maintained at higher temperature, and lower powder feed rates are often used when plasma-spraying a DVC coating onto substrate 220. In addition, the distance between the plasma spray gun and substrate 220 is often more closely controlled in the DVC process than in the porous TBC process.

Although the strain tolerance provided by dense vertically cracked TBC 260 far exceeds that required for a TBC applied to combustion hardware, maintaining processing parameters within the tight constraints discussed above is problematic when applied to combustion equipment. Thermal barrier coatings must be applied to the interior surfaces of components such as combustion liners and transition pieces. Thus, the size of the plasma spray gun that can be used to apply a TBC to such surfaces is restricted. Moreover, because such components are much larger than those (e.g., turbine airfoils) for which dense vertically cracked TBCs were originally developed, it is more difficult to maintain substrate 220 at a high deposition temperature. The additional time required to heat and maintain the component in the desired temperature range contributes to the comparatively high cycle time for applying such a coating. The present invention provides a thermally sprayed thermal barrier coating that has the ease of manufacturing of porous TBCs while having a strain tolerance that approaches that of dense vertically cracked TBCs. The TBC of the present invention possesses a balance between the tensile adhesion strength (T) and modulus of elasticity (E), such that the ratio T/E has a value within a predetermined range. The TBC of the present invention also includes both a plurality of substantially vertical cracks and a predetermined level of porosity.

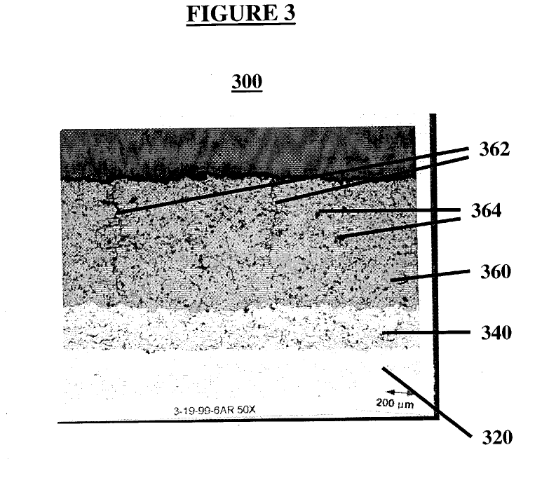

FIG. 3 is a micrograph of an article 300 of the present invention having a TBC 360 as described above. The article 300 comprises a substrate 320, a bond coat 340 disposed on a surface of the substrate 320, and TBC 360 disposed on an outer surface of bond coat 340 opposite the substrate 320. TBC 360 includes a plurality of substantially vertical cracks 362 extending therethrough and, in addition, has a predetermined level of porosity 364.

Thermal barrier coating 360 comprises a ceramic material. The ceramic material comprises at least one of a stabilized zirconia, aluminum silicate, calcium silicate, and combinations thereof. The stabilized zirconia may comprise at least one of alumina stabilized zirconia, magnesia stabilized zirconia, at least one of any rare earth metal oxide-stabilized zirconia such as, but not limited to, an yttria stabilized zirconia, a ceria stabilized zirconia, and combinations thereof. Preferably, TBC 360 is an air plasma sprayed TBC comprising yttria stabilized zirconia, wherein the yttria stabilized zirconia comprises about 8 weight percent yttria with the balance being zirconia.

Thermal barrier coating 360 of the present invention may be formed using one of the various processes and spray guns for air plasma spraying both porous and dense vertically cracked thermal barrier coatings that are well known in the art.

Commercially available air plasma spray guns, such as models 7MB™ and 3MB™, manufactured by Sulzer-Metco, and the high power plasma spray gun Plazjet™ manufactured by Praxair/TAFA, or similar air plasma spray guns may be used to form TBC 360.

It will be appreciated by those skilled in the art that process parameters such as spray or gun-to-target distance, gun power, powder feed rate, and gun speed depend upon the design characteristics of a particular spray gun. The process parameters that are used to obtain the thermal barrier coating 360 of the present invention lay between those typically selected for porous TBCs 160 and dense vertically cracked TBCs 260. In the present invention, processing parameters, such as gun power and powder feed rate, relating to the plasma generated by the spray gun, approach those of the spray processes that are used to form porous TBCs 160, whereas parameters such as spray distance or gun speed approach those used to form dense vertically cracked TBCs 260.

Thermal barrier coating 360 has a porosity 364 approximating that observed for porous TBCs. The porosity of the TBC 360 of the present invention is in the range of from about 5% to about 25%. At the same time, the TBC 360 of the present invention, like the dense vertically cracked TBC 260, includes a plurality of substantially vertical cracks 362, which are preferably oriented at an angle of less than 45 degrees from an axis that is perpendicular to an interface between the bond coat 340 and the thermal barrier coating 360. The substantially vertical cracks 362 provide the TBC 360 with additional strain tolerance, thus permitting the TBC 360 of the present invention to have a greater thickness than the porous TBC 160 of the prior art while having the same level of porosity as the porous TBC 160. The thickness of TBC 360 is typically between about 0.65 mm (about 25 mil) and about 3.05 mm (about 120 mil).

As previously presented, the ratio T/E of the tensile adhesion strength (T) to the modulus of elasticity (E) provides a qualitative estimate of strain tolerance. The TBC 360 of the present invention has a ratio of between about 6×10⁻³ and about 15×10⁻³. This ratio is between those observed for Porous TBCs 160 (typically, about 1.5×10⁻³ for Class “B” coatings and about 4-5×10⁻³ for Class “C” coatings) and dense vertically cracked TBCs 260 (typically about 20-40×10⁻³). The individual values of T and E may thus “float” within their prescribed ranges, yet are constrained by the T/E ratio.

Thermal barrier coating 360 of the present invention has a tensile adhesion strength (T) of between about 13.8 MPa (about 2000 psi) and about 34.5 MPa (about 5000 psi). In one embodiment, TBC 360 of the present invention preferably has a tensile adhesion strength of about 31 MPa (about 4,500 psi). In comparison, the tensile adhesion strength of porous TBC 160 is typically between about 10 MPa (about 1450 psi) and about 13.1 MPa (about 1900 psi), and the tensile adhesion strength of dense vertically cracked TBC 260 is typically between about 24.0 MPa (about 3500 psi) and about 58.7 MPa (about 8500 psi).

The modulus of elasticity (E) of TBC 360 of the present invention is between about 1380 MPa (about 200 ksi) and about 4830 MPa (about 700 ksi). In comparison, the modulus of elasticity of porous TBC 160 is between about 2760 MPa (about 400 ksi) and about 3453 MPa (about 500 ksi) for heat treated porous “Class C” type TBC 160, and between about 5520 MPa (about 800 ksi) and about 6890 MPa (about 1000 ksi) for porous “Class B” type TBC 160. Dense vertically cracked TBC 260 typically has a modulus of elasticity of between about 1380 MPa (about 200 ksi) and about 3450 MPa (about 500 ksi).

In the present invention, substrate 320 is a material that is capable of withstanding the high temperature conditions that are prevalent within a structure, such as a turbine assembly, having a hot gas path. Substrate 320 may comprise, for example, a nickel-base or cobalt-base superalloy, such as those currently used in turbine designs, or refractory metal intermetallic composites (hereinafter “RMICs”) that are based upon either niobium or molybdenum silicides or borides. Alternatively, a ceramic-matrix composite comprising a carbide, such as silicon carbide or the like, may serve as substrate 320. Substrate 320 may also comprise combinations of such materials.

Bond coat 340 of the present invention comprises a MCrAlY alloy, where M represents at least one transition metal other than chromium. The transition metal may be one of nickel, cobalt, iron, and combinations thereof. For example, a NiCoCrAlY alloy is sometimes used to form a bond coat. Bond coat 340 is deposited onto a surface of substrate 320 by one of low pressure plasma spraying, air plasma spraying, high velocity oxyfuel spraying, physical vapor deposition, chemical vapor deposition, plasma assisted chemical vapor deposition, and combinations thereof.

A coated article 300 of the present invention is formed by first providing a substrate 320, which may comprise one of a superalloy, a ceramic-matrix composite, and a refractory metal intermetallic composite, as previously described.

Bond coat 340, comprising a MCrAlY alloy, is then applied to a surface of substrate 320. A thermal barrier coating of a ceramic material, such as yttria stabilized zirconia, magnesia stabilized zirconia, ceria stabilized zirconia, aluminum silicate, calcium silicate, and combinations thereof, is then air plasma sprayed on the outer surface of bond coat 340, thereby forming the coated article 300. Coated article 300 may be additionally heat treated at a temperature of between about 1040° C. (about 1900° F.) and about 1200° C. (about 2200° F.) for a predetermined time, preferably between about 1 and about 4 hours.

According to the present invention, thermal barrier coating 360 of the present invention is deposited on an article by air plasma spraying a ceramic material, such as a stabilized zirconia, including, but not limited to, yttria stabilized zirconia, magnesia stabilized zirconia, ceria stabilized zirconia, alumina stabilized zirconia, and rare earth oxide-stabilized zirconias; aluminum silicate; calcium silicate; and combinations thereof, onto a surface of the article to form a coated article. The coated article is then heat treated at a temperature of between about 1040° C. (about 1900° F.) and about 1200° C. (about 2200° F.) for a predetermined time, preferably between about 1 and about 4 hours.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. An article comprising:
a) a substrate;
b) a bond coat disposed on a surface of said substrate; and
c) a thermal barrier coating disposed on a bond coat surface of said bond coat, said bond coat surface being opposite said surface, wherein said thermal barrier coating comprises a ceramic material, said thermal barrier coating having a plurality of substantially vertical cracks therein and a porosity that is within a predetermined range, and wherein a ratio of a tensile adhesion strength of said thermal barrier coating to a modulus of elasticity of said thermal barrier coating has a value between about 6×10⁻³ and about 15×10⁻³.

2. The article of claim 1, wherein said ceramic material comprises at least one of a stabilized zirconia, aluminum silicate, calcium silicate, and combinations thereof.

3. The article of claim 2, wherein said stabilized zirconia comprises at least one of alumina stabilized zirconia, magnesia stabilized zirconia, a rare earth metal oxide-stabilized zirconia, and combinations thereof.

4. The article of claim 3, wherein said rare earth metal oxide-stabilized zirconia comprises at least one of an yttria stabilized zirconia, ceria stabilized zirconia, and combinations thereof.

5. The article of claim 4, wherein said rare earth metal oxide-stabilized zirconia is yttria stabilized zirconia, and wherein said yttria stabilized zirconia comprises about 8 weight percent yttria and the balance zirconia.

6. The article of claim 1, wherein said substrate comprises at least one of a superalloy, a ceramic-matrix composite, and a refractory metal intermetallic composite.

7. The article of claim 6, wherein said superalloy is one of a nickel-base superalloy and a cobalt-base superalloy.

8. The article of claim 6, wherein said ceramic-matrix composite comprises silicon carbide.

9. The article of claim 6, wherein said refractory metal intermetallic composite is one of a niobium silicide-based refractory metal intermetallic composite and a molybdenum silicide-based refractory metal intermetallic composite.

10. The article of claim 1, wherein said bond coat comprises chromium, aluminum, yttrium, and at least one transition metal other than chromium.

11. The article of claim 10, wherein said at least one transition metal is at least one of nickel, cobalt, iron, and combinations thereof.

12. The article of claim 1, wherein said bond coat is deposited by one of low pressure plasma spraying, air plasma spraying, high velocity oxyfuel spraying, physical vapor deposition, chemical vapor deposition, plasma assisted chemical vapor deposition, and combinations thereof.

13. The article of claim 1, wherein said thermal barrier coating is an air plasma sprayed thermal barrier coating.

14. The article of claim 1, wherein said porosity of said thermal barrier coating is between about 5% and about 25%.

15. The article of claim 1, wherein each of said substantially vertical cracks is oriented at an angle of less than about 45 degrees from an axis that is perpendicular to an interface between said bond coat and said thermal barrier coating.

16. The article of claim 1, wherein said thermal barrier coating has a tensile adhesion strength of between about 13.8 MPa and about 34.5 MPa.

17. The article of claim 1, wherein said thermal barrier coating has a modulus of elasticity of between about 1380 MPa and about 4830 MPa.

18. The article of claim 1, wherein said thermal barrier coating has a thickness of between about 0.65 mm and about 3.05 mm.

19. The article of claim 1, wherein said article is a component in a turbine assembly.

20. The article of claim 19, wherein said article is a combustor liner.

21. The article of claim 19, wherein said article is a transition piece, said transition piece being disposed between a combustor liner and a nozzle.

22. A thermal barrier coating for an article, said thermal barrier coating comprising a ceramic material and having a plurality of substantially vertical cracks therein and a porosity that is within a predetermined range, and wherein the ratio of a tensile adhesion strength of said thermal barrier coating to a modulus of elasticity of said thermal barrier coating has a value between about 6×10⁻³ and about 15×10⁻³.

23. The thermal barrier coating of claim 22, wherein said ceramic material comprises at least one of a stabilized zirconia, aluminum silicate, calcium silicate, and combinations thereof.

24. The thermal barrier coating of claim 23, wherein said stabilized zirconia comprises at least one of alumina stabilized zirconia, magnesia stabilized zirconia, a rare earth metal oxide-stabilized zirconia, and combinations thereof.

25. The thermal barrier coating of claim 24, wherein said rare earth metal oxide-stabilized zirconia comprises at least one of an yttria stabilized zirconia, ceria stabilized zirconia, and combinations thereof.

26. The thermal barrier coating of claim 25, wherein said rare earth metal oxide-stabilized zirconia is yttria stabilized zirconia, and wherein said yttria stabilized zirconia comprises about 8 weight percent yttria and the balance zirconia.

27. The thermal barrier coating of claim 22, wherein said thermal barrier coating is an air plasma sprayed thermal barrier coating.

28. The thermal barrier coating of claim 22, wherein said porosity of said thermal barrier coating is between about 5% and about 25%.

29. The thermal barrier coating of claim 22, wherein each of said substantially vertical cracks is oriented at an angle of less than about 45 degrees from an axis that is perpendicular to an interface between a bond coat and said thermal barrier coating.

30. The thermal barrier coating of claim 22, wherein said thermal barrier coating has a tensile adhesion strength of between about 13.8 MPa and about 34.5 MPa.

31. The thermal barrier coating of claim 22, wherein said thermal barrier coating has a modulus of elasticity of between about 1380 MPa (about 200 ksi) and about 4830 MPa (about 700 ksi).

32. The thermal barrier coating of claim 22, wherein said thermal barrier coating has a thickness of between about 0.65 mm and about 3.05 mm.

33. An article comprising:
a) a substrate, said substrate comprising at least one of a superalloy, a ceramic-matrix composite, and a refractory metal intermetallic composite;
b) a bond coat disposed on a surface of said substrate; and
c) an air plasma sprayed thermal barrier coating disposed on a bond coat surface of said bond coat, said bond coat surface being opposite said surface, wherein said thermal barrier coating comprises at least one of a stabilized zirconia, aluminum silicate, calcium silicate, and combinations thereof, said thermal barrier coating having a plurality of substantially vertical cracks therein and a porosity that is within a predetermined range, and wherein a ratio of a tensile adhesion strength of said thermal barrier coating to a modulus of elasticity of said thermal barrier coating has a value between about 6×10⁻³ and about 15×10⁻³.

34. The article of claim 33, wherein said stabilized zirconia comprises at least one of alumina stabilized zirconia, magnesia stabilized zirconia, a rare earth metal oxide-stabilized zirconia, and combinations thereof.

35. The article of claim 34, wherein said rare earth metal oxide-stabilized zirconia comprises at least one of an yttria stabilized zirconia, ceria stabilized zirconia, and combinations thereof.

36. The article of claim 35, wherein said rare earth metal oxide-stabilized zirconia is yttria stabilized zirconia, and wherein said yttria stabilized zirconia comprises about 8 weight percent yttria and the balance zirconia.

37. The article of claim 33, wherein said superalloy is one of a nickel-base superalloy and a cobalt-base superalloy.

38. The article of claim 33, wherein said ceramic-matrix composite comprises silicon carbide.

39. The article of claim 33, wherein said refractory metal intermetallic composite is one of a niobium silicide-based refractory metal intermetallic composite and a molybdenum silicide-based refractory metal intermetallic composite.

40. The article of claim 33, wherein said bond coat comprises, chromium, aluminum, yttrium, and at least one transition metal other than chromium.

41. The article of claim 40, wherein said at least one transition metal is at least one of nickel, cobalt, iron, and combinations thereof.

42. The article of claim 33, wherein said bond coat is deposited by one of low pressure plasma spraying, air plasma spraying, high velocity oxyfuel spraying, physical vapor deposition, chemical vapor deposition, plasma assisted chemical vapor deposition, and combinations thereof.

43. The article of claim 33, wherein said porosity of said thermal barrier coating is between about 5% and about 25%.

44. The article of claim 33, wherein each of said substantially vertical cracks is oriented at an angle of less than 45 degrees from an axis that is perpendicular to an interface between said bond coat and said thermal barrier coating.

45. The article of claim 33, wherein said thermal barrier coating has a tensile adhesion strength of between about 13.8 MPa and about 34.5 MPa.

46. The article of claim 33, wherein said thermal barrier coating has a modulus of elasticity of between about 1380 MPa and about 4830 MPa.

47. The article of claim 33, wherein said thermal barrier coating has a thickness of between about 0.65 mm and about 3.05 mm.

48. The article of claim 33, wherein said article is a component in a turbine assembly.

49. The article of claim 48, wherein said article is a combustor liner.

50. The article of claim 48, wherein said article is a transition piece, said transition piece being disposed between a combustor liner and a nozzle.

51. A turbine assembly having at least one component comprising:
a) a substrate, said substrate comprising at least one of a superalloy and a refractory metal intermetallic composite;
b) a bond coat disposed on a surface of said substrate; and
c) an air plasma sprayed thermal barrier coating disposed on a bond coat surface of said bond coat, said bond coat surface being opposite said surface, wherein said thermal barrier coating comprises at least one of a stabilized zirconia, aluminum silicate, calcium silicate, and combinations thereof, said thermal barrier coating having a plurality of substantially vertical cracks therein and a porosity that is within a predetermined range, and wherein a ratio of a tensile adhesion strength of said thermal barrier coating to a modulus of elasticity of said thermal barrier coating has a value between about 6×10⁻³ and about 15×10⁻³.

52. The turbine assembly of claim 51, wherein said stabilized zirconia comprises at least one of alumina stabilized zirconia, magnesia stabilized zirconia, a rare earth metal oxide-stabilized zirconia, and combinations thereof.

53. The turbine assembly of claim 52, wherein said rare earth metal oxidestabilized zirconia comprises at least one of an yttria stabilized zirconia, ceria stabilized zirconia, and combinations thereof.

54. The turbine assembly of claim 53, wherein said rare earth metal oxidestabilized zirconia is yttria stabilized zirconia, and wherein said yttria stabilized zirconia comprises about 8 weight percent yttria and the balance zirconia.

55. The turbine assembly of claim 51, wherein said superalloy is one of a nickel-base superalloy and a cobalt-base superalloy.

56. The turbine assembly of claim 51, wherein said refractory metal intermetallic composite is one of a niobium silicide-based refractory metal intermetallic composite and a molybdenum silicide-based refractory metal intermetallic composite.

57. The turbine assembly of claim 51, wherein said bond coat comprises chromium, aluminum, yttrium, and at least one transition metal other than chromium.

58. The turbine assembly of claim 51, wherein said porosity of said thermal barrier coating is between about 5% and about 25%.

59. The turbine assembly of claim 51, wherein each of said substantially vertical cracks is oriented at an angle of less than 45 degrees from an axis that is perpendicular to an interface between said bond coat and said thermal barrier coating.

60. The turbine assembly of claim 51, wherein said thermal barrier coating has a tensile adhesion strength of between about 13.8 MPa and about 34.5 MPa.

61. The turbine assembly of claim 51, wherein said thermal barrier coating has a modulus of elasticity of between about 1380 MPa and about 4830 MPa.

62. The turbine assembly of claim 51, wherein said thermal barrier coating has a thickness of between about 0.65 mm and about 3.05 mm.

63. The turbine assembly of claim 51, wherein said component is a combustor liner.

64. The turbine assembly of claim 51, wherein said component is a transition piece, said transition piece being disposed between a combustor liner and a nozzle.

65. A method of forming a coated article, the article comprising a substrate, a bond coat disposed on the substrate, and a thermal barrier coating disposed on the bond coat, wherein the thermal barrier coating comprises a ceramic material and has a plurality of substantially vertical cracks therein and a porosity that is within a predetermined range, and wherein a ratio of a tensile adhesion strength of the thermal barrier coating to a modulus of elasticity of the thermal barrier coating has a value between about 6×10⁻³ and about 15×10⁻³, the method comprising the steps of:
a) providing a substrate;
b) depositing a bond coat on the substrate; and
c) depositing a thermal barrier coating on the bond coat, thereby forming the coated article.

66. The method of claim 65, further comprising the step of heat treating the coated article at a temperature between about 1040° C. and about 1200° C. for a predetermined time.

67. The method of claim 65, wherein the step of providing a substrate comprises providing a substrate comprising at least one of a superalloy, a ceramic-matrix composite, and a refractory metal intermetallic composite.

68. The method of claim 65, wherein the step of depositing a bond coat on the substrate comprises depositing a bond coat comprising chromium, aluminum, yttrium, and at least one transition metal other than chromium on the substrate.

69. The method of claim 65, wherein the step of depositing a bond coat on the substrate comprises depositing a bond coat by one of low pressure plasma spraying, air plasma spraying, high velocity oxyfuel spraying, physical vapor deposition, chemical vapor deposition, plasma assisted chemical vapor deposition, and combinations thereof on the substrate.

70. The method of claim 65, wherein the step of depositing a thermal barrier coating on the bond coat comprises air plasma spraying a ceramic material onto the bond coat.

71. The method of claim 65, wherein the step of air plasma spraying a ceramic material onto the bond coat comprises air plasma spraying at least one of a stabilized zirconia, aluminum silicate, calcium silicate, and combinations thereof onto the bond coat.

72. The method of claim 71, wherein the stabilized zirconia comprises at least one of alumina stabilized zirconia, magnesia stabilized zirconia, a rare earth metal oxide-stabilized zirconia, and combinations thereof.

73. The method of claim 72, wherein the rare earth metal oxide-stabilized zirconia comprises at least one of an yttria stabilized zirconia, ceria stabilized zirconia, and combinations thereof.

74. The method of claim 73, wherein the rare earth metal oxide-stabilized zirconia is yttria stabilized zirconia, and wherein the yttria stabilized zirconia comprises about 8 weight percent yttria and the balance zirconia.

75. A method of forming a thermal barrier coating on an article, the thermal barrier coating comprising a ceramic material and having a plurality of substantially vertical cracks therein and a porosity that is within a predetermined range, and wherein a ratio of a tensile adhesion strength of the thermal barrier coating to a modulus of elasticity of the thermal barrier coating has a value between about 6×10⁻³ and about 15×10⁻³, the method comprising the steps of:
a) providing an article;
b) air plasma spraying a coating of a ceramic material onto the article; and
c) heat treating the article at a temperature between about between about 1040° C. and about 1200° C. for a predetermined time, thereby forming a thermal barrier coating on the article.

76. The method of claim 75, wherein the step of air plasma spraying a ceramic material onto the article comprises air plasma spraying at least one of a stabilized zirconia, aluminum silicate, calcium silicate, and combinations thereof onto the article.

77. The method of claim 75, wherein the stabilized zirconia comprises at least one of alumina stabilized zirconia, magnesia stabilized zirconia, a rare earth metal oxide-stabilized zirconia, and combinations thereof.

78. The method of claim 77, wherein the rare earth metal oxide-stabilized zirconia comprises at least one of an yttria stabilized zirconia, ceria stabilized zirconia, and combinations thereof.

79. The method of claim 78, wherein the rare earth metal oxide-stabilized zirconia is yttria stabilized zirconia, and wherein the yttria stabilized zirconia comprises about 8 weight percent yttria and the balance zirconia.
